(19) United States
(12) Patent Application Publication
(10) Pub. No.: US 2005/0200570 A1
(43) Pub. Date: Sep. 15, 2005

(54) Drive method for plasma display panel

(76) Inventors: Hiroyuki Tachibana, Osaka (JP); Toshikazu Wakabayashi, Osaka (JP); Shigeo Kigo, Osaka (JP); Nobuaki Nagao, Osaka (JP); Kenji Ogawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/515,503

(22) PCT Filed: Mar. 23, 2004
(86) PCT No.: PCT/JP04/03946

§ 371 Date: Nov. 24, 2004

(30) Foreign Application Priority Data
Mar. 24, 2003 (JP) 2003-080302

(51) Int. Cl. G09G 3/28

(52) U.S. Cl. 345/63

(57) ABSTRACT

A method of driving a plasma display panel including a plurality of priming electrodes. The pulse width of scan pulses applied to some of a plurality of scan electrodes in which writing is performed and priming discharge is caused with the scanning of the scan electrodes is larger than the pulse width of scan pulses applied to the other scan electrodes in which writing is performed but no priming discharge is caused with the scanning of the scan electrodes.

### TECNICAL FIELD

The present invention relates to a method of driving a plasma display panel.

### BACKGROUND ART

A plasma display panel (hereinafter abbreviated as a PDP or a panel) is a display device having excellent visibility and featuring a large screen, thinness and light weight. The systems of discharging a PDP include an alternating-current (AC) type and direct-current (DC) type. The electrode structures thereof include a three-electrode surface-discharge type and an opposite-discharge type. However, the current mainstream is an AC type three-electrode PDP, which is an AC surface-discharge type, because this type of PDP is suitable for higher definition and easy to manufacture.

Generally, an AC type three-electrode PDP has a large number of discharge cells formed between a front panel and rear panel faced with each other. In the front panel, a plurality of display electrodes, each made of a pair of scan electrode and sustain electrode, are formed on a front glass substrate in parallel with each other. A dielectric layer and a protective layer are formed to cover these display electrodes. In the rear panel, a plurality of parallel data electrodes is formed on a rear glass substrate. A dielectric layer is formed on the data electrodes to cover them. Further, a plurality of barrier ribs is formed on the dielectric layer in parallel with the data electrodes. Phosphor layers are formed on the surface of the dielectric layer and the side faces of the barrier ribs. Then, the front panel and the rear panel are faced with each other and sealed together so that the display electrodes and data electrodes intersect with each other. A discharge gas is filled into an inside discharge space formed therebetween. In a panel structured as above, ultraviolet light is generated by gas discharge in each discharge cell. This ultraviolet light excites respective phosphors to emit R, G, or B color, for color display.

A general method of driving a panel is a so-called sub-field method: one field period is divided into a plurality of sub-fields and combination of light-emitting sub-fields provides gradation images for display. Now, each of the sub-fields has an initializing period, writing period, and sustaining period.

In the initializing period, all the discharge cells perform initializing discharge operation at a time to erase the history of wall electric charge previously formed in respective discharge cells and form wall electric charge necessary for the subsequent writing operation. Additionally, this initializing discharge operation serves to generate priming (priming for discharge=excited particles) for causing stable writing discharge.

In the writing period, scan pulses are sequentially applied to scan electrodes, and write pulses corresponding to the signals of an image to be displayed are applied to data electrodes. Thus, selective writing discharge is caused between scan electrodes and corresponding data electrodes for selective formation of wall electric charge.

In the subsequent sustaining period, a predetermined number of sustain pulses are applied between scan electrodes and corresponding sustain electrodes. Then, the discharge cells in which wall electric charge are formed by the writing discharge are selectively discharged and light is emitted from the discharge cells.

In this manner, to properly display an image, selective writing discharge must securely be performed in the writing period. However, there are many factors in increasing discharge delay in the writing discharge: restraints of the circuitry inhibit the use of high voltage for write pulses; and phosphor layers formed on the data electrodes make discharge difficult. For these reasons, priming for generating stable writing discharge is extremely important.

However, the priming caused by discharge rapidly decreases as time elapses. This causes the following problems in the method of driving a panel described above. In writing discharge occurring long time after the initializing discharge, priming generated in the initializing discharge is insufficient. This insufficient priming causes a large discharge delay and unstable wiring operation, thus degrading the image display quality. Additionally, when long wiring period is set for stable wiring operation, the time taken for the writing period is too long.

Proposed to address these problems are a panel and method of driving the panel in which auxiliary discharge electrodes are provided and discharge delay is minimized using priming caused by auxiliary discharge (see Japanese Patent Unexamined Publication No. 2002-297091, for example).

However, such panels have the following problems. Because the discharge delay of the auxiliary discharge itself is large, the discharge delay of the writing discharge cannot sufficiently be shortened. Additionally, because the operating margin of the auxiliary discharge is small, incorrect discharge may be induced in some panels.

Further, when the number of scan electrodes is increased for higher definition without shortening the discharge delay in the writing discharge sufficiently, the time taken for the writing period is too long and the time taken for the sustaining period is insufficient. As a result, luminance decreases. Additionally, increasing the partial pressure of xenon to increase the luminance and efficiency further increases the discharge delay and makes the writing operation unstable.

The present invention addresses these problems and aims to provide a method of driving a plasma display panel capable of performing stable and high-speed writing operation.

### DISCLOSURE OF THE INVENTION

To address these problems, in the method of driving a plasma display panel of the present invention, the pulse width of scan pulses applied to scan electrodes in which writing operation is performed but no priming discharge is caused with the scanning of the scan electrodes is shorter than the pulse width of scan pulses applied to other scan electrodes in which writing operation is performed and priming discharge is caused with the scanning of the scan electrodes, in the writing period.

### BRIEF DESCRIPTION OF THE DRAWINGS

FIG. 1 is a sectional view showing an example of a panel used for an exemplary embodiment of the present invention.

FIG. 2 is a schematic perspective view showing a structure of a rear substrate side of the panel.

FIG. 3 is a diagram showing an arrangement of electrodes in the panel.

FIG. 4 is a diagram showing a driving waveform in a method of driving the panel.

FIG. 5 is diagram showing an example of a circuit block of a driver for implementing the method of driving the panel.

### DETAILED DESCRIPTION OF PREFERRED EMBODIMENT

A method of driving a plasma display panel in accordance with an exemplary embodiment of the present invention is described hereinafter with reference to the accompanying drawings.

### Exemplary Embodiment

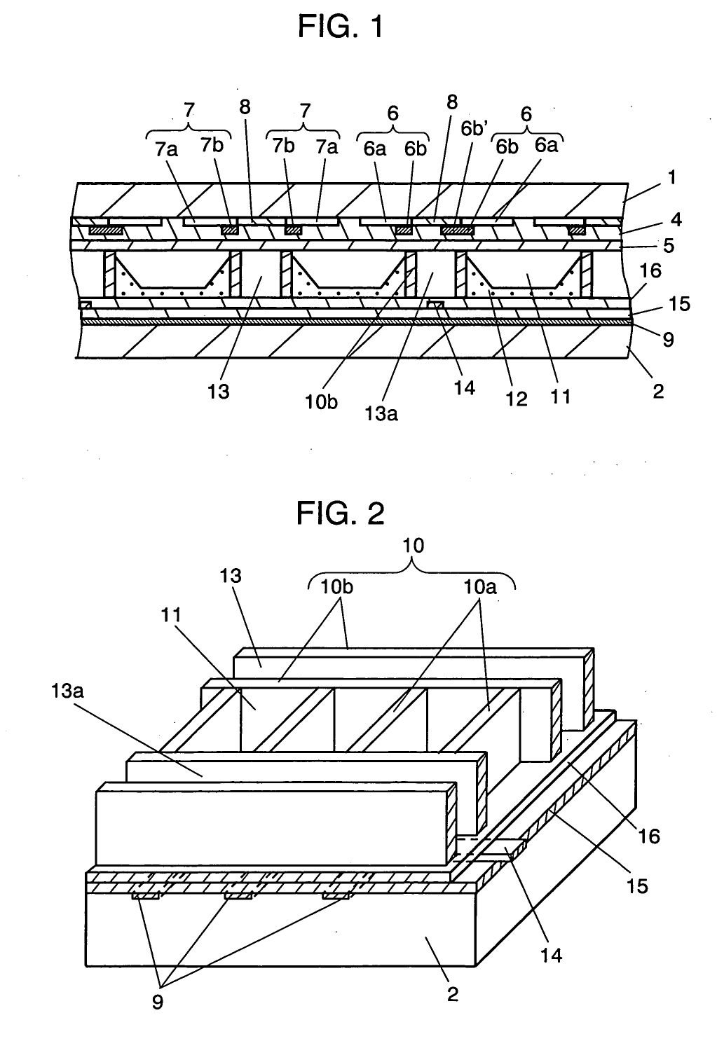

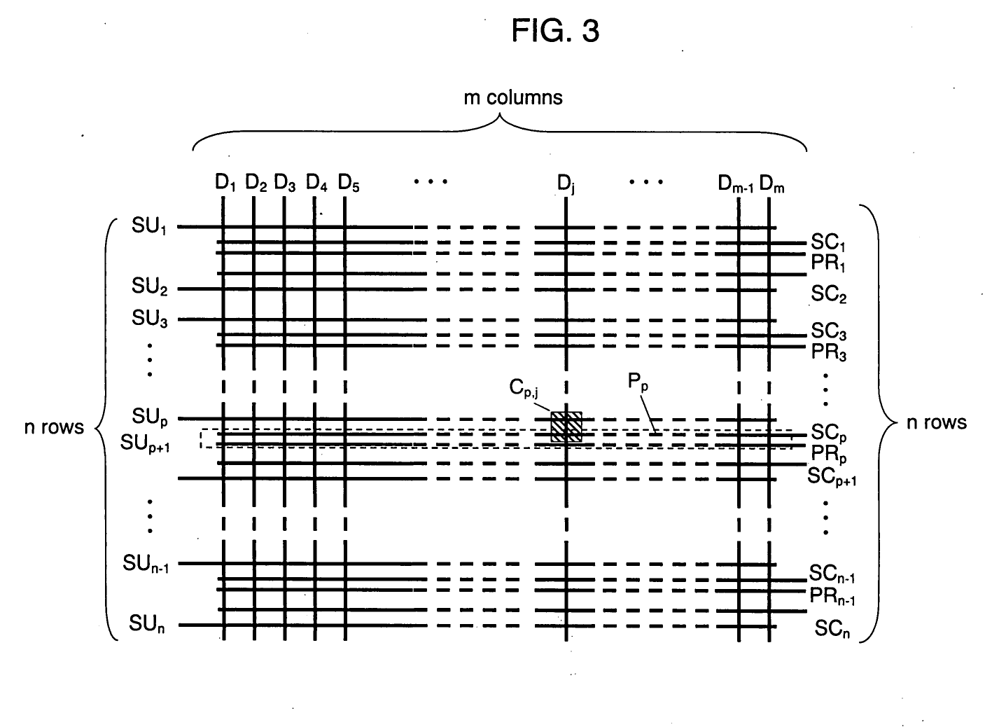

FIG. 1 is a sectional view showing an example of a panel used for the exemplary embodiment of the present invention. FIG. 2 is a schematic perspective view showing the structure of the rear substrate side of the panel.

As shown in FIG. 1, front substrate 1 and rear substrate 2 both made of glass are faced with each other to sandwich a discharge space therebetween. In the discharge space, a mixed gas of neon and xenon for radiating ultraviolet light by discharge is filled.

On front substrate 1, a plurality of pairs of scan electrode 6 and sustain electrode 7 are formed in parallel with each other. Further, scan electrodes 6 and sustain electrodes 7 are alternately arranged in pairs like sustain electrode 7—scan electrode 6—scan electrode 6—sustain electrode 7—sustain electrode 7—scan electrode 6, etc. Scan electrode 6 and sustain electrode 7 are made of transparent electrodes 6a and 7a, and metal buses 6b and 7b formed on transparent electrodes 6a and 7a, respectively. Now, between one scan electrode 6 and the other scan electrode 6, and one sustain electrode 7 and the other scan electrode 7, light-absorbing layers 8, each made of a black material, are provided. Projection 6b′ of metal bus 6b in one of adjacent scan electrodes 6 projects onto light-absorbing layer 8. Dielectric layer 4 and protective layer 5 are formed to cover these scan electrodes 6, sustain electrodes 7, and light-absorbing layers 8.

On rear substrate 2, a plurality of data electrodes 9 is formed in parallel with each other. Dielectric layer 15 is formed to cover these data electrodes 9. Further on the dielectric layer, barrier ribs 10 for partitioning the discharge space into discharge cells 11 are formed. As shown in FIG. 2, each barrier rib 10 is made of vertical walls 10a extending in parallel with data electrodes 9, and horizontal walls 10b for forming discharge cells 11 and forming clearance 13 between discharge cells 11. In clearance 13 faced with projection 6b′ in scan electrode 6 among clearances 13, priming electrode 14 is formed in the direction orthogonal to data electrodes 9, to form priming cell 13a. In other words, priming electrodes 14 are not provided in all the clearances 13, and are formed in priming cells 13 in every other one of clearances 13. On the surface of dielectric layer 15 corresponding to discharge cells 11 and the side faces of barrier ribs 10, phosphor layers 12 are provided. However, no phosphor layer 12 is formed on the side of clearances 13.

When front substrate 1 is faced and sealed with rear substrate 2, each projection 6b′ of metal bus 6b in scan electrode 6 formed on front substrate 1 that projects onto light-absorbing layer 8 is positioned in parallel with corresponding priming electrode 14 on rear substrate 2 and faced therewith in priming cell 13a. In other words, the panel shown in FIGS. 1 and 2 is structured to include priming cells 13a, each for performing priming discharge between projection 6b′ formed on the side of front substrate 1 and priming electrode 14 formed on the side of rear substrate 2.

In FIGS. 1 and 2, dielectric layer 16 is further formed to cover priming electrodes 14.

Now, to facilitate causing priming discharge, phosphor layers 12 that hinder the discharge are not provided on priming cells 13a. Further, the interval between projection 6b′ in scan electrode 6 and corresponding priming electrode 14 is shorter than the interval between data electrode 9 and corresponding scan electrode 6. Thus, the discharge-starting voltage of the priming discharge is lower than that of the writing discharge, and the priming discharge is more likely to occur.

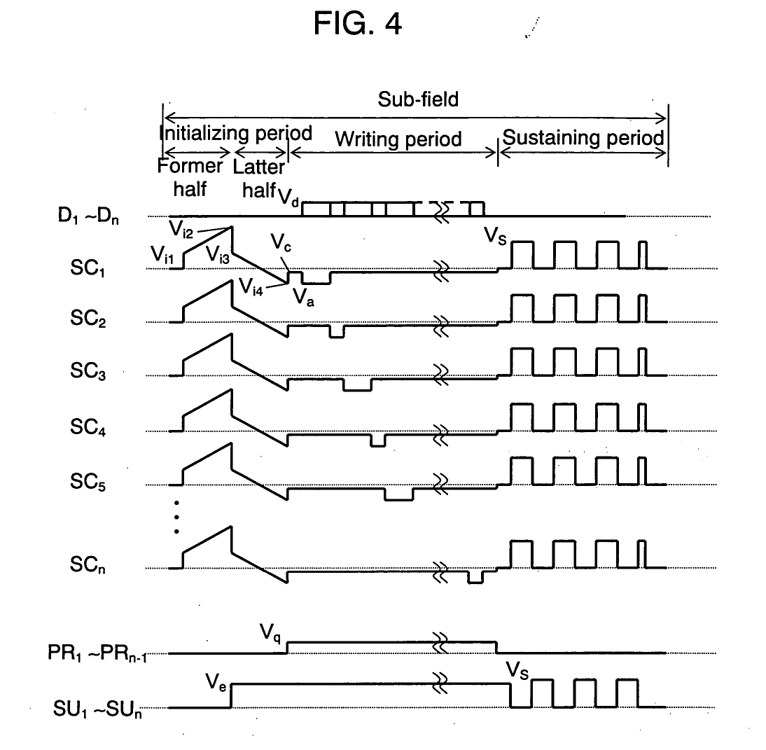

FIG. 3 is a diagram showing an arrangement of electrodes in the panel used for the exemplary embodiment of the present invention. M columns of data electrodes D₁ to Dₘ (data electrodes 9 in FIG. 1) are arranged in the column direction. N rows of scan electrodes SC₁ to SCₙ (scan electrodes 6 in FIG. 1), and n rows of sustain electrodes SU₁ to SUₙ (sustain electrodes 7 in FIG. 1) are alternately arranged in pairs in the row direction like sustain electrode SU₁—scan electrode SC₁—scan electrode SC₂—sustain electrode SU₂, etc. In this embodiment, projections 6b′ are provided only in odd-numbered scan electrodes SU₁, SU₃, etc. N/2 rows of priming electrodes PR₁, PR₃, etc. (priming electrode 14 in FIG. 1) are arranged to be faced with the corresponding projections of these scan electrodes SU₁, SU₃, etc.

Thus, m×n discharge cells Cᵢⱼ (discharge cells 11 in FIG. 1), each including a pair of scan electrode SCᵢ and sustain electrode SUᵢ (i=1 to n) and one data electrode Dⱼ (j=1 to m), are formed in the discharge space. N/2 rows of priming cells Pₚ (priming cell 13a in FIG. 1), each including projection 6b′ of scan electrode SCₚ (p=odd number) and priming electrode PRₚ, are formed.

As described above, the panel used in the embodiment of the present invention, odd-numbered scan electrodes SCₚ are scan electrodes with projections 6b′ in which writing operation is performed and priming discharge is caused with the scanning of the scan electrodes. On the other hand, even-numbered scan electrodes SCₚ₊₁ are scan electrodes with no projections 6b in which writing operation is performed but no priming discharge is caused with the scanning of the scan electrodes.

Next, a driving waveform for driving the panel and timing of the driving waveform are described.

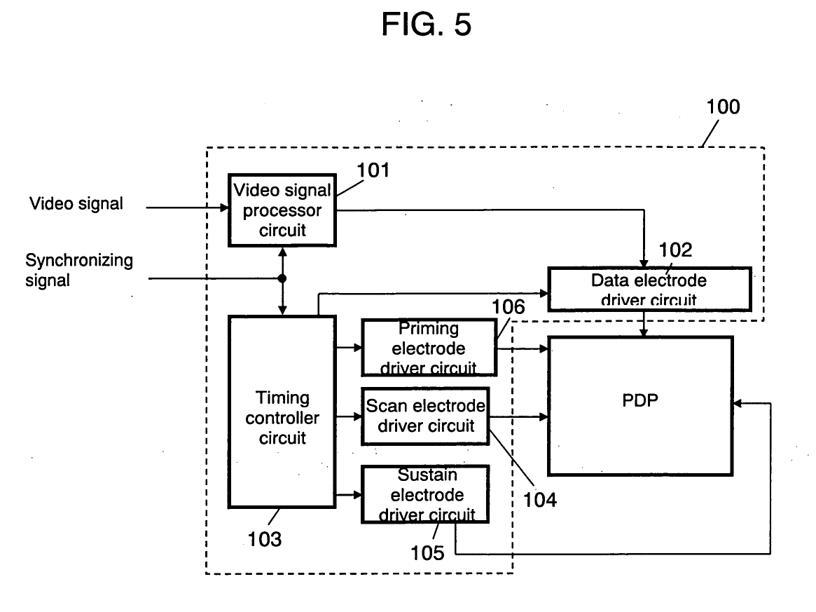

FIG. 4 is a diagram showing a driving waveform in the method of driving the panel used for the exemplary embodiment of the present invention. In this embodiment, one field period is made of a plurality of sub-fields, each including an initializing period, writing period, and sustaining period. Because the same operation is performed in each sub-field, except for the number of sustain pulses in the sustaining period, operation in one sub-filed is described hereinafter.

In the former half of the initializing period, each of data electrodes D₁ to Dₘ, sustain electrode SU₁ to SUₙ, and priming electrodes PR₁ to PRₙ₋₁ is held at 0 (V). Applied to each of scan electrodes SC₁ to SCₙ is a ramp waveform voltage gradually increasing from a voltage of Vᵢ₁ not larger than discharge-starting voltage across the scan electrodes and sustain electrodes SU₁ to SUₙ to a voltage of Vᵢ₂ exceeding the discharge-starting voltage. While the ramp waveform voltage increases, first weak initializing discharge occurs between scan electrodes SC₁ to SCₙ, and sustain electrodes SU₁ to SUₙ, data electrodes D₁ to Dₘ, and priming electrodes PR₁ to PRₙ₋₁. Thus, negative wall voltage accumulates on scan electrodes SC₁ to SCₙ, and positive wall voltage accumulates on data electrodes D₁ to Dₘ, sustain electrodes SU₁ to SUₙ, and priming electrodes PR₁ to PRₙ₋₁. Now, the wall voltage on the electrodes is the voltage generated by the wall charge accumulating on the dielectric layers covering the electrodes.

In the latter half of the initializing period, each of sustain electrode SU₁ to SUₙ is held at a positive voltage of Ve. Applied to each of scan electrodes SC₁ to SCₙ is a ramp waveform voltage gradually decreasing from a voltage of Vᵢ₃ not larger than discharge-starting voltage across the scan electrodes and sustain electrodes SU₁ to SUₙ to a voltage of Vᵢ₄ exceeding the discharge-starting voltage. During this application of the ramp voltage, second weak initializing discharge occurs between scan electrodes SC₁ to SCₙ, and sustain electrodes SU₁ to SUₙ, data electrodes D₁ to Dₘ, and priming electrodes PR₁ to PRₙ₋₁. Then, the negative wall voltage on scan electrodes SC₁ to SCₙ and the positive wall voltage on sustain electrodes SU₁ to SUₙ are weakened. The positive wall voltage on data electrodes D₁ to Dₘ is adjusted to a value appropriate for writing operation. The positive wall voltage on priming electrodes PR₁ to PRₙ₋₁ is also adjusted to a value appropriate for priming operation. Thus, the initializing operation is completed.

In the writing period, scan electrodes SC₁ to SCₙ are once held at a voltage of Vc. Then, a voltage of Vq substantially equal to voltage change V_{c}−V₁₄ is applied to priming electrodes PR₁ to PRₙ₋₁.

Next, scan pulse Va is applied to scan electrode SC₁ of the first row. Then, priming discharge occurs between priming electrode PR₁ and projection 6b′ in scan electrode SC₁. The priming diffuses inside of discharge cells C_{1,1} to C_{1, m} in the first row corresponding to scan electrode SC₁ of the first row and discharge cells C_{2,1} to C_{2, m} in the second row corresponding to scan electrode SC₂ of the second row. Because the priming cells are structured to easily discharge as described above, in this discharge, high-speed and stable priming discharge with a small discharge delay is obtained.

At the same time, positive write pulse voltage Vd is applied to data electrode Dₖ (k being an integer ranging from 1 to m) corresponding to the signal of an image to be displayed in the first row, among data electrodes D₁ to Dₘ. Then, discharge occurs at the intersection of data electrode Dₖ to which write pulse voltage Vd has been applied and scan electrode SC₁. This discharge develops to the discharge between sustain electrode SU₁ and scan electrode SC₁ in corresponding discharge cell C_{1,k}. Then, positive voltage accumulates on scan electrode SC₁ and negative voltage accumulates on sustain electrode SU₁ in discharge cell C_{1,k}. Thus, the writing operation in the first row is completed. As described above, because the priming discharge and writing discharge sequentially occur in the scanning period in the first row, the pulse width of the scan pulse applied to scan electrode SC₁ of the first row is the sum of time tp necessary for the priming discharge and time tw necessary for the writing operation, i.e. tp+tw.

Now, scan electrode SC₁ of the first row is a scan electrode in which writing is performed and the priming discharge is caused with scanning of the scan electrode. The discharge in discharge cell C_{1,k} occurs with the priming supplied from the priming discharge that has occurred between scan electrode SC₁ and priming electrode PR₁. For this reason, although there is a delay in starting the supply of the priming from the priming cell, stable discharge with a small discharge delay can be obtained after the supply of the priming.

Next, scan pulse voltage Va having a pulse width smaller than the pulse width of the pulse applied to the scan electrode of the first row is applied to scan electrode SC₂ of the second row. At this time, positive write pulse voltage Vd is applied to data electrode Dₖ corresponding to the signal of the image to be displayed in the second row, among data electrodes D₁ to Dₘ. Then, discharge occurs at the intersection of data electrode Dₖ and scan electrode SC₂. This discharge develops to the discharge between sustain electrode SU₂ and scan electrode SC₂ in corresponding discharge cell C_{2,k}. Then, positive voltage accumulates on scan electrode SC₂ and negative voltage accumulates on sustain electrode SU₂ in discharge cell C_{2,k}. Thus, the writing operation in the second row is completed.

Now, the reason why the pulse width of the scan pulse applied to scan electrode SC₂ of the second row is smaller than the first pulse width, i.e. tp+tw, is as follows. Scan electrode SC₂ is a scan electrode in which writing is performed but no priming discharge is caused with the scanning of the scan electrode. Thus, the discharge in discharge cell C_{2,k} occurs with sufficient priming already supplied from the priming discharge that has occurred between scan electrode SC₁ and priming electrode PR₁. Therefore, time tp necessary for the priming discharge need not take into account. At this time, of course, the discharge delay in the writing discharge is extremely small and stable discharge can be obtained.

In a similar manner, a scan pulse having the first pulse width of tp+tw is applied to scan electrode SC₃ of the third row, and a write pulse is applied to data electrode Dₖ. Then, priming discharge occurs between priming electrode PR₃ and scan electrode SC₃ first, and priming is supplied to discharge cells C_{3,1} to C_{3,m} in the third row and discharge cells C_{4,1} to C_{4,m} in the fourth row. Successively, writing discharge occurs in discharge cell C_{3,k} corresponding to data electrode Dₖ to which the write pulse voltage has been applied.

Next, a scan pulse having a pulse width of tw is applied to scan electrode SC₄ of the fourth row, and a positive write pulse is applied to data electrode Dₖ. Then, in corresponding discharge cell C_{3,k}, stable writing discharge with an extremely a small discharge delay is caused by the influence of the priming already supplied.

The similar writing operations are performed in discharge cells including C_{n,k} of the n-th row, and the writing operations are completed.

In this manner, in the writing operation in each of discharge cells C_{p,1} to C_{p,m} (p=odd number) in an odd-numbered row, a scan pulse having the first pulse width of tp+tw is applied to scan electrode SCₚ, and a write pulse is applied to data electrode Dₖ. Then, priming discharge occurs between priming electrodes PRₚ and scan electrodes SCₚ first, and the priming is supplied inside of discharge cells C_{p,1} to C_{p,m} and discharge cells C_{p+1,1} to C_{p+1,m}. Successively, writing discharge occurs in discharge cell C_{p,k} corresponding to data electrode Dₖ to which the write pulse voltage has been applied.

Next, in the writing operation in each of discharge cells C_{p+1,1} to C_{p+1,m} in even-numbered row, a scan pulse having a pulse width of tw is applied to scan electrode SCₚ₊₁ of the (p+1)-th row, and a write pulse is applied to data electrode Dₖ. Then, in corresponding discharge cell C_{p+1, k}, stable writing discharge having an extremely a small discharge delay is caused by the influence of the priming already supplied.

In the sustaining period, after scan electrodes SC₁ to SCₙ and sustain electrodes SU₁ to SUₙ are reset to 0 (V) once, a positive sustain pulse voltage of Vs is applied to scan electrodes SC₁ to SCₙ. At this time, in the voltage on scan electrode SC₁ and sustain electrode SUᵢ in discharge cell C_{i,j} in which writing discharge has occurred, the wall voltage accumulating on scan electrode SCᵢ and sustain electrode SUᵢ is added to sustain pulse voltage Vs. For this reason, the voltage exceeds the discharge-starting voltage and sustain discharge occurs. In a similar manner, by alternately applying sustain pulses to scan electrodes SC₁ to SCₙ and sustain electrodes SU₁ to SUₙ, sustain discharge operations are successively performed in discharge cell C_{i,k} in which the writing discharge has occurred, the number of times of sustain pulses.

As described above, unlike the writing discharge depending only on the priming in the initializing discharge in accordance with a conventional driving method, the writing discharge of the method of driving a panel in accordance with this embodiment of the present invention is performed with sufficient priming supplied from the priming discharge that has occurred during or immediately before the writing operation in respective discharge cells. This can achieve high-speed and stable writing discharge with a small discharge delay, and display a high-quality image.

Further, electrodes in the vicinity of the priming cells are priming electrodes 14 and scan electrodes 6 only. This also gives an advantage of stable action of the priming discharge itself because the priming discharge is unlikely to cause other unnecessary discharge, e.g. incorrect discharge involving the sustain electrodes.

Incidentally, because respective electrodes of an AC type PDP are surrounded by the dielectric layers and insulated from the discharge space. For this reason, direct-current components make no contribution to discharge itself. Therefore, of course, even the use of a waveform in which direct-current components are added to the driving waveform of the exemplary embodiment of the present invention can provide similar effects.

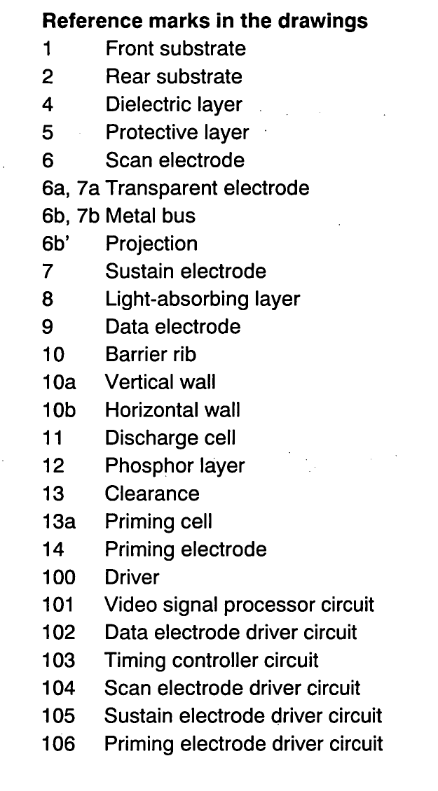

FIG. 5 is a diagram showing an example of a circuit block of a driver for implementing the method of driving the panel used for the exemplary embodiment. Driver 100 of the exemplary embodiment of the present invention includes: video signal processor circuit 101, data electrode driver circuit 102, timing controller circuit 103, scan electrode driver circuit 104 and sustain electrode driver circuit 105, and priming electrode driver circuit 106. A video signal and synchronizing signal are fed into video signal processor circuit 101. Responsive to the video signal and synchronizing signal, video signal processor circuit 101 outputs a sub-field signal for controlling whether or not to light each sub-field, to data electrode driver circuit 102. The synchronizing signal is also fed into timing controller circuit 103. Responsive to the synchronizing signal, timing controller circuit 103 outputs a timing control signal to data electrode driver circuit 102, scan electrode driver circuit 104, sustain electrode driver circuit 105, and priming electrode driver circuit 106.

Responsive to the sub-field signal and the timing control signal, data electrode driver circuit 102 applies a predetermined driving waveform to the data electrodes (data electrodes D₁ to Dₘ in FIG. 3) in the panel. Responsive to the timing control signal, scan electrode driver circuit 104 applies a predetermined driving waveform to the scan electrodes (scan electrodes SC₁ to SCₙ in FIG. 3) in the panel. Responsive to the timing control signal, sustain electrode driver circuit 105 applies a predetermined driving waveform to the sustain electrodes (sustain electrodes SU₁ to SUₙ in FIG. 3) in the panel. Responsive to the timing control signal, priming electrode driver circuit 106 applies a predetermined driving waveform to the priming electrodes (priming electrodes PR₁ to PRₙ₋₁ in FIG. 3) in the panel. Necessary electric power is supplied to data electrode driver circuit 102, scan electrode driver circuit 104, sustain electrode driver circuit 105, and priming electrode driver circuit 106 from a power supply circuit (not shown).

The above circuit block can constitute a driver for implementing the method of driving the panel of the exemplary embodiment.

As described above, the present invention can provide a method of driving a plasma display panel capable of performing stable and high-speed writing operation.

### INDUSTRIAL APPLICABILITY

As described above, the method of driving a plasma display panel of the present invention can perform stable and high-speed writing operation. Thus, the present invention is useful as a method of driving a plasma display panel.

1. A method of driving a plasma display panel comprising a plurality of scan electrodes and sustain electrodes arranged in parallel with each other, and a plurality of data electrodes arranged in a direction intersecting the scan electrodes, in which one field period is made of a plurality of sub-fields, each including an initializing period, writing period, and sustaining period, the method comprising:
providing a plurality of priming electrodes in parallel with the scan electrodes, the priming electrodes generating priming discharge between the priming electrodes and the corresponding scan electrodes; and
in the writing period, making a pulse width of a scan pulse applied to some of the scan electrodes in which writing is performed but no priming discharge is caused with scanning of the scan electrodes smaller than a pulse width of a scan pulse applied to the other scan electrodes in which writing is performed and priming discharge is caused with scanning of the scan electrodes.
